(19) United States
(12) Patent Application Publication
(10) Pub. No.: US 2007/0101408 A1
(43) Pub. Date: May 3, 2007

(54) Method and apparatus for providing authorization material

(76) Inventor: Madjid F. Nakhjiri, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/263,674

(22) Filed: Oct. 31, 2005

(51) Int. Cl. H04L 9/32

(52) U.S. Cl. 726/4

(57) ABSTRACT

Various embodiments are described to address the problem of duplicated authentication processing in authorizing servers. Generally expressed, an authorizing server (220), such as an AAA server, sends (305) authorization material to a first access service node (210), such as a foreign agent or SIP agent. The authorization material is for a second access service node (230) and corresponds to a mobile node (201). The first access service node then forwards (307) the authorization material to the second access service node. By distributing the authorization material in this way, the second access service node need not communicate with the authorizing server to obtain the authorization material and neither does the authorizing server need to send messaging to both access service nodes. Thus, benefits such as reduced authorizing server load and reduced registration delays may be realized depending on the embodiment employed.

### FIELD OF THE INVENTION

The present invention relates generally to communications network security and, in particular, to providing authorization material to mobile nodes (MNs).

### BACKGROUND OF THE INVENTION

At present, standards bodies such as IETF (Internet Engineering Task Force), OMA (Open Mobile Alliance), 3GPP (3rd Generation Partnership Project) and 3GPP2 (3rd Generation Partnership Project 2) are developing standards specifications that relate to communications network and mobile device security. (These groups may be contacted via http://www.ietf.org, http://www.openmobilealliance.com, http://www.3gpp.org/and http://www.3gpp2.com/, respectively.) For example, a number of IETF Request for Comments (RFC) documents and draft documents may be read for the purpose of obtaining some general background in this area. Particular documents include: C. Perkins, “IP Mobility support for IPv4”, RFC 3344, August 2002; C. Perkins, P. Calhoun, “Mobile IPv4 Challenge/Response Extensions”, RFC 3012, November 2000; C. Perkins, Et. Al., “Mobile IPv4 Challenge/Response Extensions (revised)”, draft-ietf-mipv4-rfc3012bis-00.txt, October 2003; and C. Perkins, P. Calhoun, “AAA registration keys for Mobile IPv4”, Internet draft, IETF, draft-ietf-mip4-aaa-key-04.txt, March 2004.

In various types of communications networks, authorizing servers are known to perform functions such as security key generation for mobile and/or fixed network nodes. Authentication, authorization, and accounting (AAA) servers are well-known examples of networking equipment that may function in an authorizing server capacity. Mobile nodes (i.e., mobile entities) are served by access service nodes which communicate with the appropriate authorizing servers to obtain the required security keys. Access service nodes and authorizing servers may utilize one or more network protocols, examples of which include Extensible Authentication Protocol (EAP), mobile internet protocol (MIP) and session initiation protocol (SIP). Thus, in a network in which MIP is used, an authorizing server may be embodied by an AAA, one access service node may be embodied by a MIP home agent (HA), and another access service node may be embodied by a MIP foreign agent (FA) or an EAP authenticator.

Although one of the more general problems that the present application addresses is not limited to MIP networks, an example of the problem is described in the context of a MIP network as follows. Roaming mobile nodes need to interact with mobile IP agents, such as a foreign agent and a home agent, to establish new routes for the forwarding of their traffic to a new location. Traditional MIP design specifies that the MN registration requests that are first received by an FA are simply forwarded to the HA of that MN for processing. To protect the mobility agents from fraudulent MIP signaling, it is required of the MNs to authenticate their registration signaling to MIP agents. However, MNs bootstrapping in a foreign network have no trust relationship with the FA or HA. IETF has been working on a method to allow the MIP agents to outsource the registration authentication to the AAA servers.

FIG. 1 is a messaging flow diagram 100 depicting an MN registration via an FA in an MIP network, in accordance with prior art techniques. According to the IETF method, the FA forwards the registration request (105) to the AAA server for authentication verification, and the AAA server then forwards the authorized request to the HA for MIP processing. However, because the AAA RADIUS protocol is a reactive protocol, AAA servers employing RADIUS are not able to send unsolicited orders. In other words, the RADIUS server can only send the result of authentication verification back to the FA (reactive signaling).

Diameter is a more modern AAA protocol than RADIUS and can function in both reactive and proactive mode. Thus, Diameter AAA servers are able to send unsolicited commands to the MIP HAs to request a MIP registration processing. However, Diameter presently has a very small deployment base in the industry, while RADIUS is the most widely deployed AAA protocol today. Instead, the method that is being suggested for RADIUS is that the AAA server sends the authorization response (110) to the FA and the FA then forwards the same registration request (115) to the HA again. Since the HA cannot trust either the MN or FA, the HA needs to outsource the verification of MN credentials (120) to the AAA server, as the FA did previously.

Therefore, the AAA server must process the same authentication process twice for each registration. Given the typically high loading level of AAA servers and the sensitivity to AAA servers as single failure points in the network, this dual processing situation is undesirable. Moreover, accessing the AAA server twice during each registration adds significant delay to the initial MIP registration. Accordingly, it would be desirable to have a method and apparatus for providing authorization material more efficiently.

### BRIEF DESCRIPTION OF THE DRAWINGS

FIG. 1 is a messaging flow diagram depicting an MN registration via an FA in an MIP network, in accordance with prior art techniques.

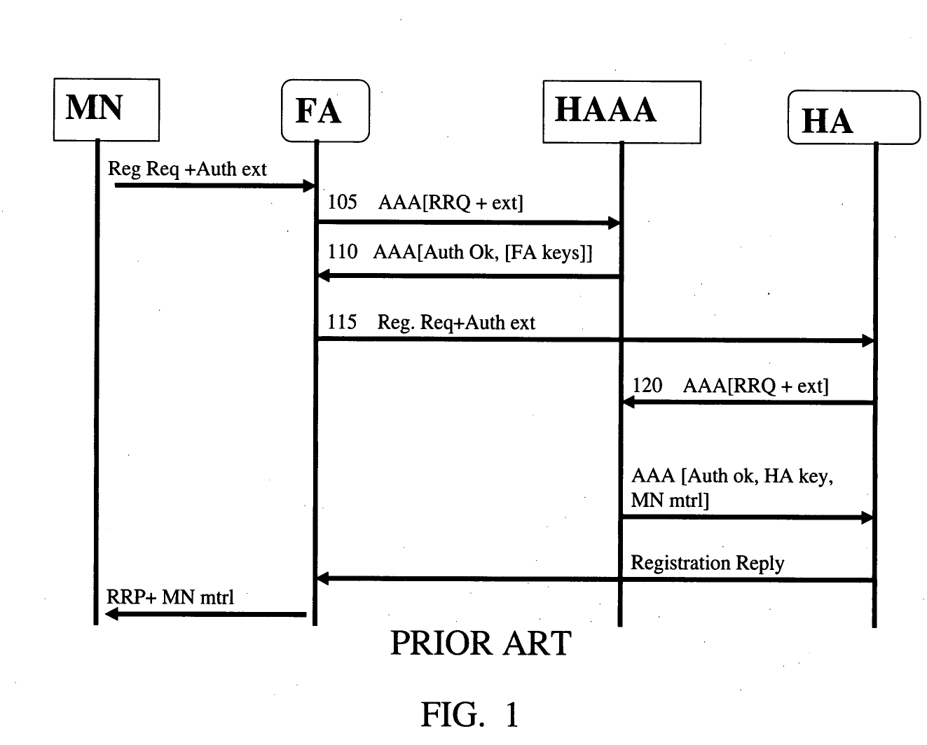

FIG. 2 is a block diagram depiction of a communications network in accordance with multiple embodiments of the present invention.

FIG. 3 is a messaging flow diagram depicting an authorizing server providing authorization material in accordance with multiple embodiments of the present invention.

FIG. 4 is a block diagram depiction of a communications network in accordance with multiple embodiments of the present invention that utilize MIP messaging.

FIG. 5 is a messaging flow diagram depicting an MN registration via an FA in an MIP network, in accordance with multiple embodiments of the present invention.

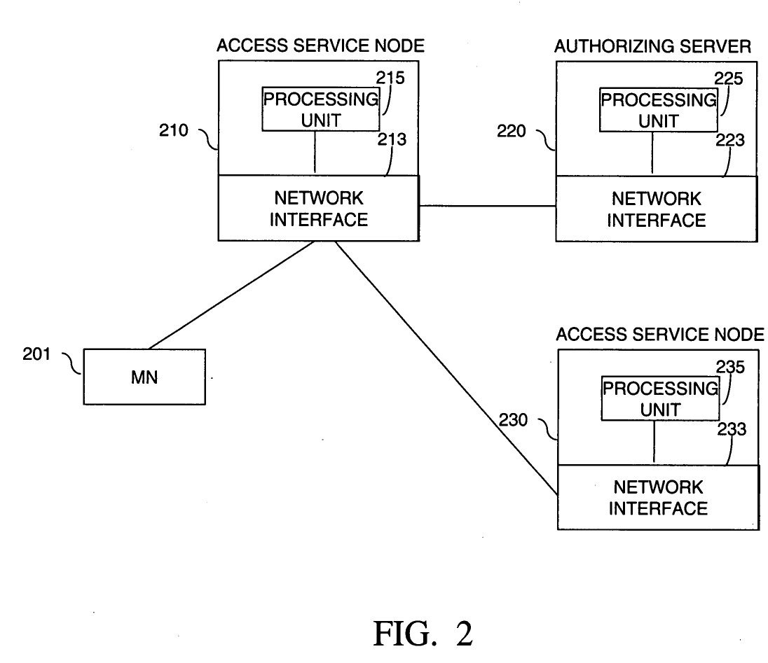

Specific embodiments of the present invention are disclosed below with reference to FIGS. 2-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to address the problem of duplicated authentication processing in authorizing servers. Generally expressed, an authorizing server, such as a RADIUS or a Diameter type AAA server, sends authorization material to a first access service node, such as a foreign agent or SIP agent. The authorization material is for a second access service node and corresponds to a mobile node. The first access service node then forwards the authorization material to the second access service node. By distributing the authorization material in this way, the second access service node need not communicate with the authorizing server to obtain the authorization material and neither does the authorizing server need to send messaging to both access service nodes. Thus, benefits such as reduced authorizing server load and reduced registration delays may be realized depending on the embodiment employed.

The present invention can be more fully understood with reference to FIGS. 2-5. FIG. 2 is a block diagram depiction of a communications network 200 in accordance with multiple embodiments of the present invention. More specifically, communication network 200 comprises mobile node (MN) 201, access service nodes 210 and 230, and authorizing server 220. Those skilled in the art will recognize that FIG. 2 does not depict all of the network equipment necessary for network 200 to operate but only those network components and logical entities particularly relevant to the description of embodiments herein. For example, in embodiments in which MN 201 comprises a wireless device, network 200 may also comprise a radio access network (RAN), a wireless local area network (WLAN) or some other wireless access network. However, none of these additional networks or their component devices are specifically shown in FIG. 2.

Thus, communication network 200 is depicted generically to encompass many different embodiment classes. For example, authorizing server 220 performs security key generation for mobile and/or fixed network nodes. As such, authorizing server 220 may be embodied as an authentication, authorization, and accounting (AAA) server, for example, and may serve as MN 201's home AAA (HAAA or AAAH).

Similarly, access service nodes 210 and 230 may be embodied in many different ways depending on the particular network configuration and the particular network protocols used. In embodiments in which access service node 230 employs mobile internet protocol (MIP or mobile IP), access service node 230 may be embodied as a home agent (HA) for MN 201. Alternatively, in embodiments in which session initiation protocol (SIP) is employed, access service node 230 may be embodied as a SIP agent.

In embodiments in which access service node 210 employs mobile IP, access service node 210 may be embodied as a foreign agent (FA). Alternatively, in embodiments in which SIP is employed, access service node 210 may be embodied as a SIP agent. For clarity, it is noted that “SIP agent” refers to a class of SIP devices that includes more particular SIP embodiments such as SIP proxies or SIP servers. Access service node 210 may alternatively be embodied as a network service function (NSF). Again for clarity, it is noted that “NSF” refers to a class of network devices that includes more particular embodiments such as AAA clients, authenticators (e.g., an EAP authenticator), key distributors or other network entities that may interface with HAs. Thus, in some embodiments, access service node 230 may be embodied by a MIP HA, while access service node 210 is not embodied as a MIP FA. For example, access service node 210 may be embodied as one of the other alternatives described above.

Access service nodes 210 and 230 and authorizing server 220 are depicted in FIG. 2 as respectively comprising processing units 215, 235 and 225 and respectively comprising network interfaces 213, 233 and 223. In general, components such as processing units and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams.

Thus, given an algorithm, a logic flow, a messaging/signaling flow, and/or a protocol specification, those skilled in the art are aware of the many design and development techniques available to implement a processing unit that performs the given logic. Therefore, access service nodes 210 and 230 and authorizing server 220 represent known network devices that have been adapted, in accordance with the description herein, to implement multiple embodiments of the present invention. Furthermore, those skilled in the art will recognize that aspects of the present invention may be implemented in and across various physical components and none are necessarily limited to single platform implementations.

As with access service nodes 210 and 230 and authorizing sever 220, MN 201 may be embodied in many different ways depending on the particular networks involved. MN 201 may be embodied as any mobile network-connecting device. As a mobile entity, MN 201 may be, for example, a mobile router or mobile user equipment (UE). UEs may be wireless devices, such as mobile stations (MSs), but they do not need to be wireless; a UE may be either wired or wireless. Moreover, UE platforms are known to refer to a wide variety of consumer electronic platforms such as, but not limited to, MSs, access terminals (ATs), terminal equipment, gaming devices, personal computers, personal digital assistants (PDAs), cable set-top boxes and satellite set-top boxes.

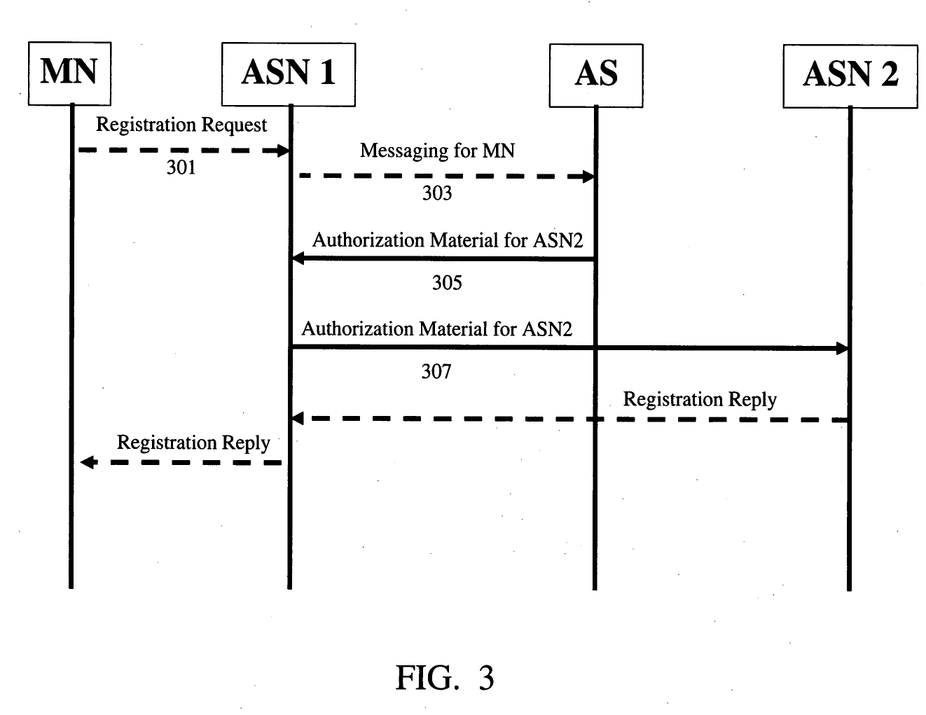

Operation of embodiments in accordance with the present invention occurs substantially as follows, first with reference to both FIGS. 2 and 3. FIG. 3 is a messaging flow diagram 300 depicting an authorizing server providing authorization material in accordance with multiple embodiments of the present invention. Processing unit 225 of authorizing server 220 sends (305), to access service node 210 via the network interface 223, authorization material for access service node 230 that corresponds to MN 201. Processing unit 215 of access service node 210 receives via network interface 213 the authorization material and then forwards (307) it to access service node 230. In this way, access service node 230 need not communicate with authorizing server 220 for the authorization material and neither does authorizing server 220 need to send messaging to both access service nodes 210 and 230.

However, in some embodiments access service node 230 does not trust either MN 201 or access service node 210. To address this issue, the authorization material may be protected using a keyed security algorithm and a key known by access service node 230. Thus, authorizing server 220 may protect the authorization material using a security algorithm such as a symmetric key or a public key algorithm. Secure hash algorithm (SHA-XX) is an example of a symmetric key algorithm that may be used, while RSA (Rivest, Shamir, and Adleman) is an example of a public key algorithm that may be used. By way of example, then, in some of the MIP embodiments a symmetric key, shared by the AAA and the home agent (an AAA-HA key), is used by the AAA with a secure hash algorithm to protect the authorization material for the home agent, which is being sent via the foreign agent. In some other MIP embodiments, a public key known by the AAA (an HA public key) is used by the AAA with RSA to protect the authorization material.

The content of the authorization material is dependent on the embodiment, and there are many different parameter combinations possible. In general, authorization material typically refers to keying material and/or authorization parameters. For example, the authorization material may include keying material to be shared by MN 201 and access service node 230. In some of the MIP embodiments, this keying material is a symmetric key that is to be shared by the MN and the home agent (an MN-HA key). In some of the SIP embodiments, this keying material may be key(s) for one or more SIP agents. Other pieces of information that may be included in the authorization material include: an identifier of MN 201 (an MN-ID), an identifier of access service node 230, a timestamp of authorizing server 220, a timestamp of MN 201, a key lifetime, and/or a key usage scope.

What information is included in the authorization material, the use and meaning of the information included and even the meaning of the information not included is all dependent on the embodiment. For example, the key lifetime and key usage scope may refer to the included key material respectively indicating, for example, the lifetime of the key material and the usage scope of the key material. The lifetime of the key material may be indicated with respect to an included authorizing server timestamp. The usage scope can indicate how the key material should be used, for example, by this access service node, whether by others, whether for further key generation, whether with certain protocols (such as MIP, SIP, etc.), whether for certain operations (such as registrations), etc. If an MN timestamp is included, it can be extracted from messaging received from MN 201 and can be used for anti-replay purposes. In another example, the inclusion of an access service node identifier can indicate that the key material is only for that access service node, while the exclusion of an access service node identifier can indicate that the key material may be shared with other access service nodes. A few examples of authorization material content have been provided; however, these examples by no means form an exhaustive list. Many others are possible, although not listed or described fully herein.

As described above, authorizing server 220 sends (305), to access service node 210, authorization material for access service node 230 that corresponds to MN 201. Access service node 210 then forwards (307) the authorization material to access service node 230. Depending on the embodiment, the sending of the authorization material may be uninitiated (as perhaps in the case of some embodiments in which the authorizing server is a Diameter type server) or it may be triggered by messaging received by access service node 210. The uninitiated case was described earlier.

Messaging flow diagram 300 also depicts an example of a case in which the sending of the authorization material is initiated by other messaging. In this example, access service node 210 receives (301) registration request messaging from MN 201. In response, access service node 210 sends (303) to authorizing server 220 messaging corresponding to MN 201. In this example, the messaging sent to authorizing server 220 takes the form of access request messaging to determine whether MN 201 is authorized for service. In its response to access service node 210, authorizing server 220 indicates MN 201's authorization and includes the authorization material for access service node 230 that corresponds to MN 201.

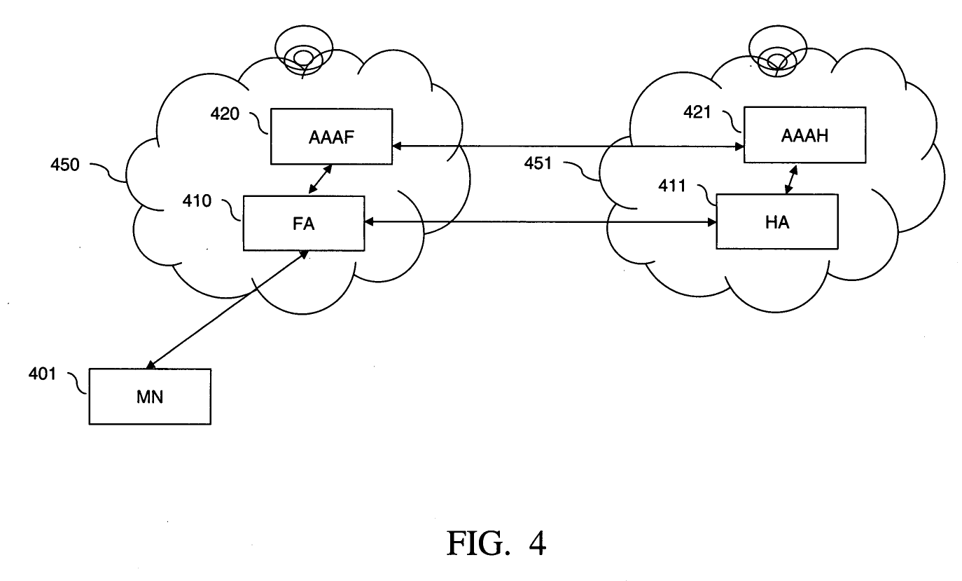

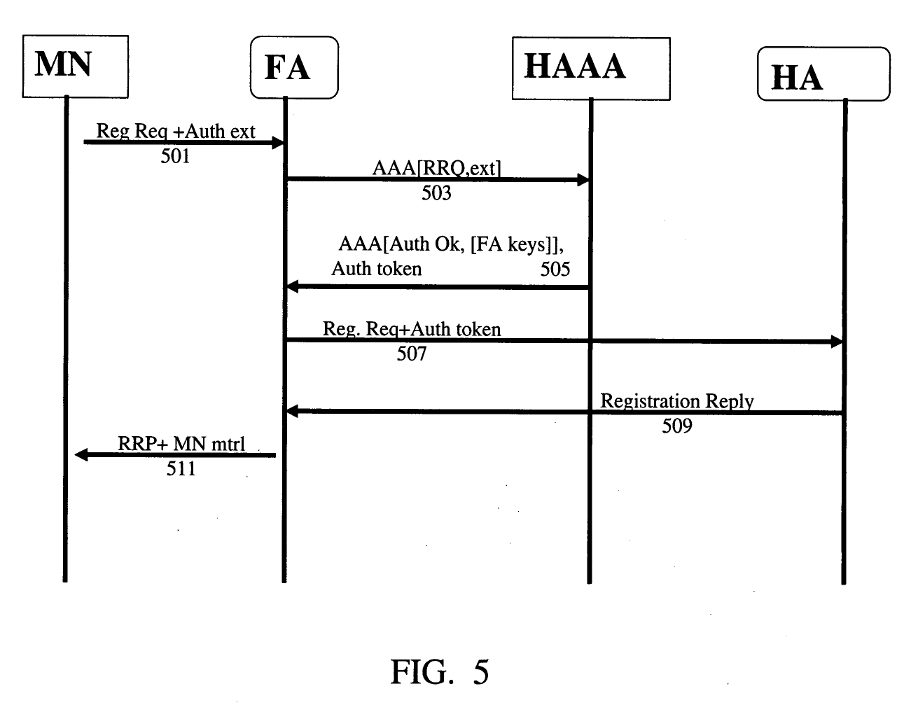

The preceding description with respect to FIGS. 2 and 3 has been at a more general level in order to accommodate many of the embodiments envisioned. In contrast, the following description with respect to FIGS. 4 and 5 is intended to provide greater operational details but for a limited number of embodiments that employ mobile IP. The description that follows should not be construed as limiting the preceding description but rather as expanding its disclosure by way of providing numerous specific examples.

FIG. 4 is a block diagram depiction of a communications network 400 in accordance with multiple embodiments of the present invention that utilize MIP messaging. Communications network 400 depicts two sub-networks with respect to MN 401, home network 451 and visited/foreign network 450. The other components depicted include the following with their mobile IP definitions (for the purposes of this detailed description, not their only envisioned mobile IP definitions):

Home agent (HA) 411
A Mobile IP home agent that is responsible for generating and keeping a binding between mobile node home address and its care of address (CoA).

Foreign Agent (FA) 410
A Mobile IP foreign agent that is responsible for serving the mobile node in foreign network 450.

Home AAA server (AAAH)
The AAAH is a RADIUS server that operates in home network 451, which is the network that holds the user record. An assumption that is made is that the MN shares a key, called MN-AAA key with its home RADIUS server. This MN-AAA key is the basis for the creation of the keys that are created dynamically between MN and its mobility agents. Also, the security associations that are created as a result of Mobile IP-AAA signaling are called mobility security association (MSA)[MIPKEYS].

Foreign AAA server (AAAF) 420
The AAAF is a RADIUS server that acts as a “forwarding server”, forwarding RADIUS packets to AAAH 421. The AAAF resides in the same domain that hosts the FA in the foreign network or hosts the HA when the HA is also in the foreign network. Other Broker AAA “proxy servers” may exist between the AAAF and the AAAH. However, to keep the scenario discussions simple the entire AAA infrastructure is treated as consisting of a AAAF and a AAAH, but note that in the multi-domain scenario, the operation may involve a number of AAA proxies (AAA nodes operating between AAAF and AAAH) to provide Mobile IP-RADIUS interaction for a roaming mobile node.

FIG. 5 is a messaging flow diagram 500 depicting an MN registration via an FA in an MIP network, in accordance with multiple embodiments of the present invention. An MN being served by an FA, with whom the MN does not have an MSA, forms (501) a registration request (RRQ) including MN-AAA authentication extension and MN-HA-key-generation-nonce-request, MN-FA-key-generation-nonce-request [MIPKEYS] and challenge extensions [IETF RFC 3012] and sends this message to FA. The MN calculates the MN-AAA-Authenticator as follows:
Authenticator=MD5(High-order byte from Challenge ∥ Key ∥ MD5(Preceding Mobile IP data ∥Type, Subtype (if present), Length, SPI) ∥ Least-order 237 bytes from Challenge)

The FA checks the challenge and extracts the necessary information from the RRQ to form (503) the attributes to be included in a RADIUS Access Request message. The FA sends this request towards the AAA infrastructure (either AAAF or to AAAH directly). The FA calculates a hash of the RRQ as follows and inserts in MIP-HASH-RRQ. The FA may set the appropriate flags within MIP-feature vector to indicate to the AAAH that it requires keys for FA-MN-MSA and FA-HA-MSA. The FA needs to create the SPIs for any MSA for which it requests key material from AAA server. If the HA IP address is available from RRQ, the FA includes it inside MIP-HA-IP-address attribute (Note that when the RRQ includes ALL_ZEROS_OR_ONES in the HA field, the HA field will not convey the HA identity to the AAA server). Otherwise the FA inserts the HA NAI from the RRQ inside the MIP-HA-ID attribute. Note that at least one of MIP-HA-IP-address and MIP-HA-ID needs to be present for identification of the HA at the AAA server. The FA includes its own identifier (e.g. NAI) inside the NAS-ID. The following attributes are included in this request:

RADIUS-Access Request {
<User-Name>, (preferably MIP-MN-NAI from RRQ)
<MIP-MN-HoA>, (from RRQ)
<MIP-HA-IP-address> (from RRQ if available),
<MIP-HA-ID> (as per RADIUS specification)
NAS-ID (as per RADIUS specification)
<MIP-MN-CoA> (from RRQ)
MIP-MN-AAA-SPI,
MIP-MN-FA challenge,
MIP-HASH-RRQ,
MIP-MN-AAA-Authenticator,
MIP-feature-vector
Message-Authenticator(80)}

The RADIUS Access request will eventually arrive at the AAAH through the AAA infrastructure. The AAAH server computes its own copy of the MN-AAA authenticator as follows:

Authenticator = MD5(
High-order byte from Challenge ∥ Key ∥
Value of MIP-HASH-RRQ ∥
Least-order 237 bytes from Challenge)

The AAAH compares this value with what it has received in MIP-MN-AAA-Authenticator attribute from FA. If authentication is successful, the AAAH generates the FA-HA key (if required), the MN-FA key and the MN-FA nonce for MN (for MN-FA MSA) as well as the MN-HA key for HA and the MN-HA nonce for MN and sends (505) a RADIUS Access-Accept message as shown below to the FA. E[K1, K2) denotes encryption of Key K2 with key K1.

RADIUS Access Accept {
<user-name>
<MIP-MN-HoA>
E [AAA-FA key, MIP-FA-HA key],
E [AAA-HA key, MIP-FA-HA key],
MIP-FA-to-HA-SPI,
MIP-HA-to-FA-SPI,
MIP-FA-HA-ALGORITHMID,
MIP-FA-HA-MSA-LIFETIME,
E [AAA-FA key, MIP-MN-FA key],
E [AAA-HA key, MIP-MN-HA key],
MIP-MN-to-FA-SPI,
MIP-FA-to-MN-SPI,
MIP-MN-to-HA-SPI,*
MIP-HA-to-MN-SPI,*
MIP-MN-FA-nonce,
MIP-MN-HA-nonce,*
MIP-MN-FA-MSA-LIFETIME,
MIP-MN-FA-ALGORITHMID,
MIP-MN-HA-MSA-LIFETIME,*
MIP-MN-HA-ALGORITHMID,*
Message-Authenticator (80)
}

The FA retrieves the MN-FA key, FA-HA key (encrypted with AAA-FA key) and other materials related to MN-FA MSAs and FA-HA MSAs from the received Access-Accept. The FA builds the MSA with the HA and relays (507) the initial registration request including the MN-AAA Authentication extension to the HA. In this message, the FA appends the FA-HA Authentication extension with the authenticator computed using the received FA-HA key. The FA-HA authentication extension also includes the SPI that is copied from the received MIP-FA-to-HA-SPI attribute. The FA includes the keying material destined for the HA (MN-HA-key, FA-HA-key) as well as the MSA related material (nonces, lifetimes and algorithm identifiers) inside a registration request extension (HA-keying extension) to the HA. Note that the AAA server may opt to encrypt most of this information at the same time or separately (as shown above). The attributes marked with * are the attributes that are optionally encrypted separately or included inside a token that includes the keys for the HA.

Upon receiving the registration request from the FA, The HA extracts the HA-keying extension from the registration request sent by the FA. The HA uses AAA-HA key to decrypt the keying material (MN-HA key and HA-FA key) and any other MSA related material that was encrypted. Using the newly extracted keys, verifies the FA-HA-Authenticator. If successful, the HA processes the registration request and builds the HA-MN-MSA and HA-FA-MSA. The HA builds (509) the registration reply for the MN, adds an MN-HA authentication extension, MN-HA nonce-key reply extension and the HA-FA authentication extension if required and forwards it to the FA. As this embodiment of the present invention illustrates, the HA no longer needs to go to the AAA server for the authentication material it requires. Finally, the FA relays (511) the RRP back to the MN as described in [IETF RFC 3344] and [MIPKEYS] after building the MN-FA authentication extension when required.

Note that the initial registration request includes an MN-AAA-authentication extension that is to be verified by the AAA server. Since the MN has been already authenticated by the AAA server in the first reference from the FA, the HA does not need to process this extension (forwarding it through an Access Request to the AAA server). The HA has no use for this extension, so the FA may either simply forward the extension to the HA, (which upon seeing the keying material sent by the AAA server corresponding to MN will take that as a sign of the MN having been authenticated) or the FA may replace the MN-AAA-Authentication extension with the HA-keying extension defined in this specification.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) are intended to encompass all the various techniques available for communicating or referencing the object being indicated. Some, but not all examples of techniques available for communicating or referencing the object being indicated include the conveyance of the object being indicated, the conveyance of an identifier of the object being indicated, the conveyance of information used to generate the object being indicated, the conveyance of some part or portion of the object being indicated, the conveyance of some derivation of the object being indicated, and the conveyance of some symbol representing the object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared librarydynamic load library, a source code, an object code and/or an assembly code.

What is claimed is:

1. A method for providing authorization material comprising:
sending, by an authorizing server, authorization material for a second access service node to a first access service node, wherein the authorization material corresponds to a mobile node (MN).

2. The method of claim 1, further comprising sending, to the first access service node in addition to the authorization material, a response to messaging corresponding to the MN that was received by the authorizing server from the first access service node.

3. The method of claim 1, wherein at least one of the access service nodes from the group consisting of the first access service node and the second access service node comprises a mobile internet protocol (MIP) agent.

4. The method of claim 1, wherein the authorization material comprises at least one piece of information from the group consisting of:
keying material to be shared by the MN and the second access service node,
an identifier of the MN (MN-ID),
an identifier of the second access service node,
a timestamp of the authorizing server,
a timestamp of the MN,
a lifetime for a key, and
a usage scope for a key.

5. The method of claim 1, wherein the authorization material is protected using a keyed security algorithm and a key known by the second access service node.

6. The method of claim 5,
wherein the keyed security algorithm comprises an algorithm from the group consisting of a symmetric key algorithm and a public key algorithm, and
wherein the key comprises a key from the group consisting of a symmetric key and a public key.

7. A method for providing authorization material comprising:
receiving, by a first access service node from an authorizing server, authorization material for a second access service node, wherein the authorization material corresponds to a mobile node (MN); and
forwarding, by the first access service node to the second access service node, the authorization material.

8. The method of claim 7, further comprising
sending, by the first access service node to the authorizing server, messaging corresponding to the MN; and
receiving, by the first access service node from the authorizing server in addition to the authorization material, a response to the messaging corresponding to the MN.

9. The method of claim 8, further comprising
receiving, by the first access service node, registration request messaging from the MN, wherein the messaging corresponding to the MN is sent to the authorizing server in response to the registration request messaging.

10. The method of claim 7, wherein the authorization material comprises at least one piece of information from the group consisting of:
keying material to be shared by the MN and the second access service node,
an identifier of the MN (MN-ID),
an identifier of the second access service node,
a timestamp of the authorizing server,
a timestamp of the MN,
a lifetime for a key, and
a usage scope for a key.

11. The method of claim 7, wherein authorization material is protected using a keyed security algorithm and a key known by the second access service node.

12. An authorizing server for providing authorization material, the authorizing server comprising:
a network interface adapted to send and receive messaging to and from a network; and
a processing unit, communicatively coupled to the network interface,
adapted to send, via the network interface, authorization material for a second access service node to a first access service node, wherein the authorization material corresponds to a mobile node (MN).

13. The authorizing server of claim 12, wherein the authorizing server comprises a server from the group consisting of
an authentication, authorization, and accounting (AAA) server and
a home AAA for the MN.

14. The authorizing server of claim 12, wherein the first access service node comprises a network device from the group consisting of
a mobile internet protocol (MIP) foreign agent (FA),
a session initiation protocol (SIP) agent, and
a network service function.

15. The authorizing server of claim 12, wherein the second access service node comprises a network device from the group consisting of
a mobile internet protocol (MIP) home agent (HA) and
a session initiation protocol (SIP) agent.

16. An access service node for providing authorization material, the access service node comprising:
a network interface adapted to send and receive messaging to and from a network; and
a processing unit, communicatively coupled to the network interface,
adapted to receive, from an authorizing server via the network interface, authorization material for a second access service node, wherein the authorization material corresponds to a mobile node (MN), and
adapted to forward, to the second access service node via the network interface, the authorization material.

17. The access service node of claim 16, wherein the authorizing server comprises a server from the group consisting of
an authentication, authorization, and accounting (AAA) server and
a home AAA for the MN.

18. The access service node of claim 16, wherein the access service node comprises a network device from the group consisting of
a mobile internet protocol (MIP) foreign agent (FA),
a session initiation protocol (SIP) agent, and
a network service function.

19. The access service node of claim 16, wherein the second access service node comprises a network device from the group consisting of
a mobile internet protocol (MIP) home agent (HA) and
a session initiation protocol (SIP) agent.
